(19) United States
(12) Patent Application Publication
(10) Pub. No.: US 2022/0403486 A1
(43) Pub. Date: Dec. 22, 2022

(54) WELDABLE ALUMINIUM ALLOYS COMPRISING ZN AS MAIN ALLOYING ELEMENT FOR DIRECT METAL LASER SINTERING

(71) Applicant: EOS GmbH Electro Optical Systems, Krailling (DE)

(72) Inventors: Maija Nystroem, Turku (FI); Jukka Simola, Loimaa (FI); Hannu Heikkinen, Naantali (FI)

(73) Assignee: EOS GmbH Electro Optical Systems, Krailling (DE)

(21) Appl. No.: 17/777,409

(22) PCT Filed: Nov. 18, 2019
(86) PCT No.: PCT/EP2019/081572

§ 371 Date: May 17, 2022

(51) Int. Cl. C22C 21/10; B22F 10/28; B22F 10/64; B33Y 10/00; B33Y 40/20; B33Y 70/00

(52) U.S. Cl. CPC C22C 21/10; B22F 10/28; B22F 10/64; B33Y 10/00; B33Y 40/20; B33Y 70/00; B22F 2301/052; B22F 2301/205; B33Y 30/00

(57) ABSTRACT

Disclosed are powder mixtures for use in the manufacture of three dimensional objects. In the respective powder mixtures, a first material includes an aluminium alloy or a mixture of elemental precursors thereof, and is in powder form. The second material includes a metal powder of Zr and/or Hf. By the addition of the second material, it is possible to prepare three dimensional objects with high ultimate tensile strength and yield strength by additive manufacturing. Further disclosed are processes for the preparation of corresponding powder mixtures and three dimensional objects, the three dimensional objects themselves, devices for implementing the processes, and uses of the powder mixture.

The invention concerns powder mixtures for use in the manufacture of three dimensional objects by means of additive manufacturing, wherein the powder mixture comprises a first material and a second material. In the respective powder mixtures, the first material comprises an aluminium alloy or a mixture of elemental precursors thereof, and is in powder form and the second material comprises a metal powder of Zr and/or Hf. The invention further concerns processes for the preparation of corresponding powder mixtures and three dimensional objects, three dimensional objects prepared accordingly and devices for implementing processes for the preparation of such objects, as well as a use of a corresponding powder mixture to improve one or more of the ultimate tensile strength and the yield strength of an aluminium alloy based three-dimensional object.

### STATE OF THE ART

Aluminium alloys, and in particular aluminium alloys providing high strength, are subject of intensive research in the manufacture of vehicles and aeroplanes, particularly automobiles, as there is a continuous aim at improving the performance and fuel efficiency. Today, many light metal components for automotive applications are made of aluminium and/or magnesium alloys and are often used to form load-bearing components, which must be strong and stiff and have good strength and ductility (e.g., elongation). High strength and ductility are particularly important for safety requirements and robustness in vehicles such as automobiles. While conventional steel and titanium alloys provide high temperature resistance, these alloys are either heavy or relatively expensive.

An inexpensive alternative of light metal alloys for forming structural components in vehicles are alloys based on aluminium. Such alloys can conventionally be processed by bulk forming processes, such as by extrusion, rolling, forging, stamping, or casting techniques, such as die casting, sand casting, investment casting (fine casting), gravity die casting and the like, to the desired components.

In recent years, “rapid prototyping” or “rapid tooling” has gained more and more attention in metalworking. These methods are also known as selective laser sintering and selective laser melting. In this case, a thin layer of a material in powder form is applied repeatedly and the material is selectively solidified in each layer in the areas in which the later product is located. By exposure to a laser beam, the material is first melted at predetermined positions and then solidified. Thus, a complete three-dimensional body can successively be built.

A method for producing three-dimensional objects by selective laser sintering or selective laser melting and an apparatus for carrying out this method is disclosed, for example, in EP 1 762 122 A1.

Various aluminium alloys for selective laser melting are known and available on the market from the prior art. These materials are predominantly AlSi materials such as AlSi10Mg, AlSi12, AlSi9Cu3, which, however, have only average strengths and microstructures.

A high-strength alloy for additive manufacturing of the AlMgSc type is described in EP 3 181 711 A1. In these alloys, intermetallic Al—Sc phases have a strong strength-increasing effect, so that yield strengths of >400 MPa are achieved. The Sc required for these alloys, which is used in amounts of 0.6 to 3 wt.-%, is however very expensive and the material is also heavily dependent on the production of sufficient amounts of scandium. A further disadvantage is that the alloys described in EP 3 181 711 A1 are not suitable for use temperatures of >180° C., since the AlMg matrix tends to soften and creep.

Another approach to alloys for use in additive manufacturing are Al-MMC (MMC=matrix metal composite) concepts, which have similar mechanical properties at room temperature as AlMgSc alloys of EP 3 181 711 A1. The problem with these materials, however, is that they show a significant decrease in strength at temperatures above 200° C. A further problem of the Al-MMC concepts is that the material consists of a powder mixture of two or more components, which makes transportation, storage and reuse difficult, since a change in the mixing ratio cannot be excluded by the physical processes. Another disadvantage is the negative recycling behaviour of MMC metal-ceramic composites and the fact that the mechanical post-processing of Al-MMC is more difficult and associated with higher costs.

A further problem associated with the production of high strength aluminium alloys is that they are often quite susceptible to hot cracking when processed by welding. Alloys of this type are especially found in the 7xxx series (Al—Zn, wherein Zn is present as the principle alloy ingredient), which to this date has prevented the use of such alloys in additive manufacturing methods.

Hot cracking, or solidification cracking, occurs in aluminium welds when high levels of thermal stress and solidification shrinkage are present while the weld is undergoing various degrees of solidification. The hot cracking sensitivity of any aluminium alloy is influenced by a combination of mechanical, thermal and metallurgical factors.

Probably the most important factor affecting the hot crack sensitivity of aluminium welds is the temperature range of dendrite coherence and the type and amount of liquid available during the solidification process. Coherence is when the dendrites begin to inter-lock with one another to the point that the melted material begins to form a mushy stage. The coherence range is the temperature between the formation of coherent interlocking dendrites and the solidus temperature. The wider the coherence range, the more likely hot cracking will occur because of the accumulating strain of solidification between the interlocking dendrites.

In additive manufacturing methods, as only a small part of the alloy is melted and re-solidified in each step of the process, the strain on the material is even higher than which conventional casting, as the heating and cooling rates in the part to be melted and solidified are significantly higher than in conventional casting. This has the effect that hot cracking in aluminium alloys susceptible to hot cracking is found to be much more pronounced when an object is prepared by additive manufacturing compared to the same object, which is prepared by conventional casting.

On the other hand, as stated above such aluminium alloys have particular advantages for the production of structures and components for the automobile and aeroplane sector, such as they are lightweight and low cost and have sufficient corrosion resistance. In addition, the portfolio of shapes which can be realized by conventional casing is limited so that it may not be possible to construct parts from such aluminium alloys. Thus, there is a demand in the art for corresponding alloys, which can be processed by additive manufacturing methods to provide corresponding parts while as much as possible avoiding hot cracking to provide objects having the required physical characteristics.

In addition, there is a need for objects and parts prepared accordingly, as well as methods, by which such objects and parts can be prepared.

The present application addresses these needs.

### DESCRIPTION OF THE INVENTION

Accordingly, in a first aspect the present invention concerns a powder mixture for use in the manufacture of a three dimensional object by means of an additive manufacturing method, wherein the powder mixture comprises a first material and a second material, wherein the first material comprises an aluminium alloy or a mixture of elemental precursors thereof and is in powder form and wherein the second material comprises a metal powder of Zr and/or Hf material.

The term “aluminium alloy” is meant to be understood as that the powder comprises aluminium as the major part of the aluminium alloy, i.e. aluminium preferably contributes to at least 60 wt.-%, more preferably at least 70 wt.-% and even more preferably at least 80 wt.-% of the total of the aluminium alloy.

In a preferred embodiment of the first aspect, the aluminium alloy is an aluminium alloy with Zn as the principle alloy co-metal. I.e. except for aluminium, the content of other metals in the alloy is less than that of Zn in such aluminium alloys.

The aluminium alloy can be used as an aluminium alloy with the composition of the final aluminium alloy to be prepared (except for the second material and the optional reinforcement material), or can be used as a pre-alloy with one or more, but not all of the constituents of aluminium alloy to be prepared. In this case, the elements missing the in pre-alloy, relative to the final aluminium alloy to be prepared, can be added in elemental or alloyed form to form the first material. The term “elemental” in this regard designates that the material consists of only the respective element, except for unavoidable impurities.

In the alternative, the first material can also contain elemental precursors of an aluminium alloy to be formed upon processing by means of an additive manufacturing method. In this alternative, the aluminium is not in the form of an alloy, but is used as the pure precursor of the alloy. To this end, the aluminium is in elemental form, except for unavoidable impurities found in regular pure aluminium.

As in this alternative aluminium is in substantially pure form (i.e. is pure except for unavoidable impurities), it is clear that the first material is not solely constituted of powder particles of the aluminium, but comprises additional powder particles, wherein the entirety of the particles of the first material has the same composition of the final aluminium alloy (except for the Zr and/or Hf in the second powder). For example, it is possible that the first material comprises substantially pure precursors of each metal to form the final aluminium alloy or comprises aluminium and one or more particles of mixtures of one or more other metal precursors of the final aluminium alloy. In such mixtures, the metal should conventionally be in a form from which the metals can be converted into the final aluminium alloy by heating.

In addition, irrespective of whether the first material comprises an aluminium alloy or a mixture of elemental precursors thereof, it is preferred that the first material does not comprise substantial quantities of non-metal compounds, such as ceramic compounds or precursors of ceramic compound, which during a later processing can react with metal constituents of the aluminium alloy. Ceramic compounds on heat treatment can regularly not be disintegrated, so that they would remain as introduced in the first material and can potentially disrupt the final form or microstructure of the aluminium alloy to be formed. Thus, in a preferred aspect all the constituents of the first material have the oxidation number 0 and are not present in oxidized form (except for unavoidable impurities).

In one preferred embodiment, the first material of the powder mixture comprises aluminium and 4.0 to 6.1 wt.-% Zn, 1.5 to 3.0 wt.-% Mg, up to 0.6 wt.-% of Fe, up to 0.50 wt.-% of Si and one or more of up to 0.35 wt.-% of Cr, up to 0.5 wt.-% of Mn, up to 2.0 wt.-% of Cu, up to 0.25 wt.-% of Ti and 0.1 to 0.25 wt.-% of Zr. In a more preferred embodiment, the first material of the powder mixture comprises aluminium and 4.0 to 5.2 wt.-% Zn, 2.0 to 3.0 wt.-% Mg, up to 0.45 wt.-% of Fe, up to 0.50 wt.-% of Si and one or more of up to 0.35 wt.-% of Cr, 0.05 to 0.5 wt.-% of Mn, up to 0.25 wt.-% of Cu, up to 0.15 wt.-% of Ti and 0.1 to 0.25 wt.-% of Zr. In a yet more preferred embodiment the first material of the powder mixture comprises less than or equal to 0.25 wt.-% of Cu, less than or equal to 0.35 wt.-% of Cr and 0.05 to 0.5 wt.-% of Mn, wherein the combined amount of Mn and Cr is >0.15 wt.-%.

In an alternative more preferred embodiment, the first material of the powder mixture comprises 5.0 to 6.1 wt.-% Zn, 1.5 to 3.0 wt.-% Mg, 1.0 to 2.0 wt.-% Cu an optionally any of the further ingredients as mentioned above. More preferably, the first material of the powder mixture comprises 5.3±0.3 wt.-% Zn, 2.0±0.3 wt.-% Mg, 0.15±0.05 wt.-% Fe, 0.1±0.03 wt.-% Si, 0.20±0.05 wt.-% Cr, 0.01±0.1 wt.-% Mn, 1.5±0.25 wt.-% Cu, up to 0,005 wt.-% Zr.

If the first material is a mixture of elemental precursors, the respective amounts of the constituents will be adjusted such that a resulting aluminium alloy formed therefrom meets these amount limitations. Similarly, if the aluminium in the first material is pre-alloyed the final composition of the first material will be adjusted such that a resulting aluminium alloy formed therefrom will meet these amount limitations.

The powder to constitute the first material has to have a particle size, which enables an adequate processing when the powder is employed in an additive manufacturing method. Suitably, the first material has a particle size as expressed by a median grain size d50 (as determined by laser scattering or laser diffraction), of 1 μm or more, and preferably 10 μm or more. On the other hand, the median grain size of the first material should preferably be 150 μm or less and more preferably 75 μm or less. The d50 in the context of the determination of particle sizes is determined e.g. according to ISO 13320:2009, e.g. with a HELOS device from Sympatec GmbH.

In a preferred embodiment of the invention, the particles of the first material are substantially spherical. Corresponding particles can e.g. be prepared by atomization and cooling of the respective element or alloy melts.

The second material in the inventive powder mixture comprises a metal powder of Zr and/or Hf. In this regard, it is noted that Zr and Hf are notoriously tough to separate from each other so that most Zr and Hf metal powders will contain some amount of the respective other element. In a preferred embodiment, the second material consist of metal powder of Zr and/or Hf.

In exceptional cases, it is also possible to incorporate Zr and/or Hf in form of a precursor of elemental Zr or Hf, wherein the precursor is decomposed upon processing the powder mixture to provide elemental Zr or Hf. Suitable precursors for this purpose are e.g. hydrides of the respective metals, which may also contribute to stabilizing the second material if it is incorporated in nano-sized form.

For the second material, for the purposes of this invention, it is regularly sufficient that the amount is comparatively small relative to the amount of the first material, i.e. the amount thereof is regularly 8 wt.-% or less, preferably 5 wt.-% or less, more preferably 4.5 wt.-% or less and even more preferably 4.2 wt.-% or less in the powder mixture. On the other hand, the amount of the second material must be sufficiently high to provide the intended effect of the prevention or suppression of cracking. Therefore, in a preferred embodiment, the amount of the second material in the powder mixture is 0.1 wt.-% or more, preferably 1 wt.-% or more, more preferably 2 wt.-% or more and even more preferably 2.5 wt.-% or more.

Further as indicated above, the particle size of the second material should be small enough to ensure an as good as possible uniform distribution of the second material in the powder mixture and the individual portions thereof, which during the additive manufacturing are molten/softened and resolidified. In this respect, it has been found in the investigations underlying the invention that a suitable median grain size d50 of the second material for this purpose is a median grain size d50 of 1 μm or more, preferably 4 μm or more, and/or 100 μm or less and preferably 50 μm or less. In addition, it is preferred that the median grain size d50 of the second material is less than that of the first material. In addition, the second material can also be nano-sized, and can preferably have a particle size on less than 250 nm, more preferably less than 150 nm and even more preferably less than 100 nm.

The particles of the second material can have different forms including spherical, flake-like and/or spherically flattened form and the particles can be uniform or irregular. In a preferred embodiment, the particles of the second material are substantially spherical. While in the present invention it has been found that the metal powder of Zr and/or Hf is the key ingredient to provide crack suppression, it has also been found that the addition of a further reinforcement material provides for further improvements in terms of the ultimate tensile strength and yield strength which is obtainable in the final material. Thus, in a preferred embodiment, the inventive powder mixture further comprises a reinforcement material, which is selected form carbides, borides and nitrides. Particularly suitable carbides, borides and nitrides include TiC, ZrC, Nb₂C, Ta₂C, Al₄C, HfC, TaC, NbC, VC, SiC, B₄C, NbB₂, TaB₂, VN, NbN, AlN, TaN, Nb₂N, Ta₂N and BN.

Thus, the inventive powder mixture preferably comprises one or more of these materials. More preferably, the inventive powder mixture comprises B₄C and/or TiC.

For the reinforcement material, for the purposes of this invention, it is regularly sufficient that the amount is comparatively small relative to the amount of the first material and preferably also smaller than the amount of the second material. The amount of the reinforcement material is thus is regularly 3 wt.-% or less, preferably 2 wt.-% or less and more preferably 1.2 wt.-% or less in the powder mixture. On the other hand, the amount of the second material must be sufficiently high to provide the intended effect of improving the ultimate tensile strength and/or yield strength. Therefore, in a preferred embodiment, the amount of the second material in the powder mixture is 0.1 wt.-% or more, preferably 0.3 wt.-% or more and more preferably 0.5 wt.-% or more.

The particle size of the reinforcement material should be small enough to ensure an as good as possible uniform distribution of the reinforcement material in the powder mixture and the individual portions thereof, which during the additive manufacturing are molten/softened and resolidified. In this respect, it has been found in the investigations underlying the invention that a suitable median grain size d50 of the reinforcement material for this purpose is a median grain size d50 of equal to or less than 50 μm, preferably equal to or less than 30 μm. In addition, it is preferred that the median grain size d50 of the second material is less than that of the first and second material.

In one particularly preferred embodiment, the reinforcement material has a particle size d50 in the μm range of 1 to 15 μm. In another particularly preferred embodiment, the reinforcement material is nano-sized and has a particle size d50 of 100 nm or less and preferably 50 nm or less.

A second aspect of the present invention concerns a process for the preparation of a powder mixture as described herein above, wherein the powder mixture is produced by mixing the first material, the second material and the optional reinforcement material in a predetermined mixing ratio. Preferably, the mixing in this process is by dry mixing.

A third aspect of the present invention concerns a process for the manufacture of a three-dimensional object, which is a process for the manufacture of a three-dimensional object from a powder mixture by selective layer-wise consolidation of the powder mixture, and preferably selective layer-wise solidification of the powder mixture by means of an electromagnetic radiation and/or a particle radiation, at positions that correspond to a cross-section of the object in a respective layer, wherein the powder mixture is a powder mixture for use in the manufacture of a three-dimensional object by means of an additive manufacturing method, wherein the powder mixture comprises a first material and a second material powder, wherein the first material comprises an aluminium alloy or a mixture of elemental precursors thereof and is in powder form, wherein the second material comprises a metal powder of Zr and/or Hf, and wherein the powder mixture is adapted to form an object when solidified by means of an electromagnetic and/or a particle radiation in the additive manufacturing method. Using this method, for example a three-dimensional object with reduced cracking compared to the same three-dimensional object, which is prepared with only the powder of the first material can be manufactured.

Preferably, the process for the manufacture of a three-dimensional object comprises the steps:
providing a powder mixture as defined above, and
preparing the object by applying the mixture layer on layer and selectively solidifying the mixture, in particular by application of electromagnetic radiation, at positions in each layer, which correspond to the cross section of the object in this layer, wherein the positions are scanned in at least one interaction zone, in particular in a radiation interaction zone of an energy beam bundle.

Without being bound by any theory, it is believed that when the particles of the Zr and/or Hf metal powder are evenly distributed in the melt of the materials constituting the first material, they influence the solidification behaviour of the cooling melt in a manner that the formation of large grains that shrink during solidification and as a result tear apart from each other causing cracks is significantly reduced or avoided. In direct metal laser sintering, the cooling of the melt is much faster than in conventional manufacturing methods. Thus, the forces created during solidification are greater than e.g. in a conventional casting process.

The three-dimensional object may be an object of a single material (i.e., a material resulting from the processing of the powder mixture as described above) or an object of different materials. If the three-dimensional object is an object of different materials, this object can be produced, for example, by applying the powder mixture of the invention, for example, to a base body or pre-form of the other material.

In the process of the third aspect, by changing the temperature at which the three-dimensional object is prepared together with the Zr and/or Hf metal powder particles in the alloy matrix formed during processing the cracking in the final microstructure of aluminium alloy can be reduced. Thus, in the context of the inventive process, it may be expedient if the powder mixture of the invention is preheated via heating of the building platform to which the powder mixture is applied prior to selective solidification, with preheating to a temperature of at least 120° C. being preferred, preheating to a temperature of at least 150° C. being more preferred, and preheating to a temperature of at least 190° C. may be specified as still more preferred. On the other hand, preheating to very high temperatures places considerable demands on the apparatus for producing the three-dimensional objects, i.e. at least to the container in which the three-dimensional object is formed, so that in one embodiment a maximum temperature for the preheating of at most 400° C. and preferably at most 350° C. can be specified.

The amount of energy introduced into the powder mixture should on the one hand be sufficient to soften or melt all components on the first material and provide sufficient thermal energy to allow for the formation of the desired alloy from respective precursors, if necessary. To this purpose, it has been found that the amount of energy per volume of the powder mixture should preferably be 20 J/mm³ or more, and preferably 35 J/mm³ or more. On the other hand, the amount of energy introduced should be kept close to the minimum that is necessary to induce the alloy formation, so that preferably, the amount of energy per volume of the powder mixture should be kept at 140 J/mm³ or less and more preferably 120 J/mm³ or less.

While the inventive process is particularly advantageous as a laser sintering or laser melting process, it can also be implemented as a process, wherein the three dimensional object is formed form the first material, second material and the optional reinforcement material by application of a binder on each of the individual layers formed, and by consolidating the thus generated pre-forms by sintering to provide the final three-dimensional objects. In this case, the binders are disintegrated to gaseous products, so that the binders are no longer present in the final product.

For the inventive process, it is further preferred that the individual layers, which are subsequently subjected at least in part to treatment with electromagnetic radiation, are applied at a thickness of 10 μm or more, preferably 20 μm or more and more preferably 30 μm or more. Alternatively or cumulatively, the layers are applied at a thickness of preferably 100 μm or less, more preferably 80 μm or less and even more preferably 60 μm or less. In a most preferred embodiment the thickness, in which the layers are applied is in the range of 30 to 50 μm.

In the inventive process, it has in addition been found that a heat treatment of the three dimensional object significantly improves the physical characteristics thereof, e.g. in particular the ultimate tensile strength and the yield strength. Possibly, this effect is due to rearrangements in the microstructure in the alloy of the three dimensional object initially formed. To this end, the inventive process preferably further includes a step of subjecting the three-dimensional object initially prepared to a heat treatment, preferably at a temperature from 400° C. to 500° C., and/or for a time of 20 to 200 min. As particularly preferred temperature range a range of 420° C. to 470° C. and especially at least 430° C. and/or 450° C. or less can be mentioned. Particularly preferred time frames for the heat treatment are 30 min to 120 min and especially at least 40 min and/or 80 min or less. In addition, it has been found that such heat treatment provides particularly advantageous results, if after such heat treatment at comparatively high temperature the three dimensional object is quickly cooled to about ambient temperature (i.e. in 10 min or less and preferably 5 min or less, e.g. by quenching with water) and subsequently aged at a temperature of from 90° C. to 150° C., in particular at least 110° C. and/or at 140° C. or less for at least 12 h and preferably at least 18 h.

The three-dimensional object according to a fourth aspect of the invention is a three dimensional object manufactured from a powder mixture by selective layer-wise solidification of the powder mixture by means of an electromagnetic and/or particle radiation at positions that correspond to a cross-section of the object in a respective layer, wherein the powder mixture is a powder mixture for use in the manufacture of a three-dimensional object by means of an additive manufacturing method, wherein the powder mixture comprises a first material and a second material, wherein the first material comprises an aluminium alloy or a mixture of elemental precursors thereof, wherein the second material comprises a Zr and/or Hf metal powder, and wherein the powder mixture is adapted to form an object when solidified by means of electromagnetic and/or particle radiation in the additive manufacturing method. The three-dimensional object has, for example, reduced hot-cracking compared to the same three-dimensional object, which is prepared with only the first material.

The three-dimensional object according to the invention in a forth aspect is preferably a three-dimensional object, wherein the material of the three-dimensional object has an ultimate tensile strength of more than 400 MPa and preferably at least 420 and/or 650 MPa or less, and/or a yield strength of more than 300 MPa and preferably for at least 400 MPa and/or 650 MPa or less, and/or an elongation of equal to or less than 15% and preferably of at least 2 and/or 12% or less.

For specific embodiments of the first material, the second material and the optional reinforcement material in the above three-dimensional object, reference is made to the above preferred embodiments which have been described in connection with the inventive powder mixtures.

The amount of second material and the optional reinforcement material in the above three-dimensional object can be determined by microscopic measurement of the area occupied by the reinforcement material in a transversal section through the three-dimensional object vs. the area occupied by the metal alloy.

For the three-dimensional object of either of the above fourth aspect, it is preferred that they have a relative density of 98% or more, preferably 99% or more and more preferably 99.5% or more, wherein the relative density is defined as the ratio of the measured density and the theoretical density. The theoretical density is the density which can be calculated from the density of the bulk materials used to prepare the three-dimensional object (basically metal alloy and reinforcement material) and their respective ratios in the three-dimensional object. The measured density is the density of the three-dimensional object as determined by the Archimedes Principle according to ISO 3369:2006.

In a fifth aspect, the present invention concerns the use of a powder mixture as described above for improving one or more of the ultimate tensile strength and the yield strength of an aluminium alloy based three dimensional object, wherein the three-dimensional object is prepared in a process involving the step- and layerwise build-up of the three-dimensional object by additive manufacturing, preferably by laser sintering or laser melting.

Finally, in a sixth aspect the present invention concerns a device for implementing a process as described above in the third aspect, wherein the device comprises an electromagnetic radiation application device, preferably as a a laser sintering or laser melting device, a process chamber having an open container with a container wall, a support, which is inside the process chamber, wherein open container and support are moveable against each other in vertical direction, a storage container and a recoater, which is moveable in horizontal direction, and wherein the storage container is at least partially filled with a powder mixture as described in the first aspect.

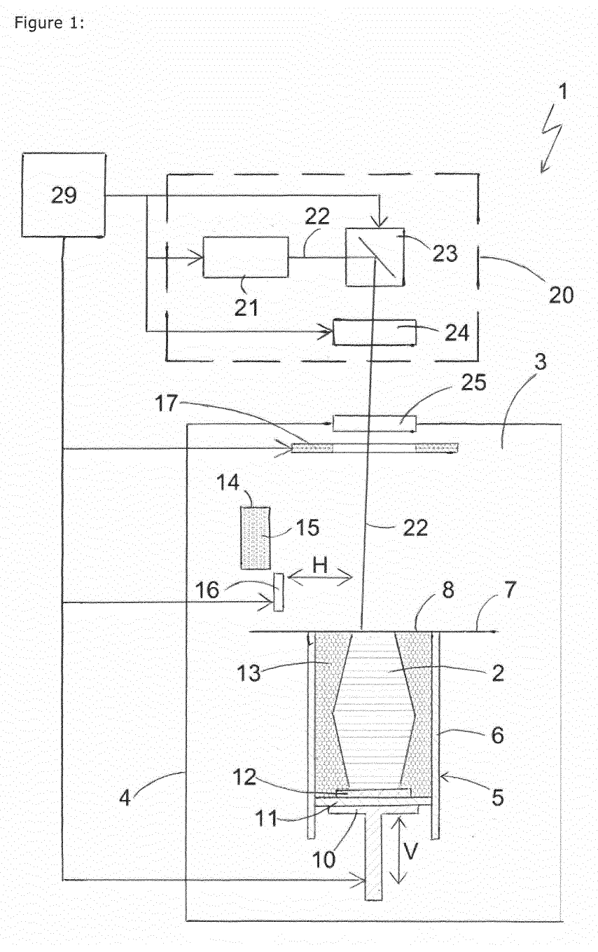

Other features and embodiments of the invention are provided in the following description of an exemplary embodiment taking account of the appended FIG. 1.

The device represented in FIG. 1 is a laser sintering or laser melting apparatus 1 for the manufacture of a three-dimensional object 2. The apparatus 1 contains a process chamber 3 having a chamber wall 4. A container 5 being open at the top and having a container wall 6 is arranged in the process chamber 3. The opening at the top of the container 5 defines a working plane 7. The portion of the working plane 7 lying within the opening of the container 5, which can be used for building up the object 2, is referred to as building area 8. Arranged in the container 5, there is a support 10, which can be moved in a vertical direction V, and on which a base plate 11 which closes the container 5 toward the bottom and therefore forms the base of the container 5 is attached. The base plate 11 may be a plate which is formed separately from the support 10 and is fastened on the support 10, or may be formed so as to be integral with the support 10. A building platform 12 on which the object 2 is built may also be attached to the base plate 11. However, the object 2 may also be built on the base plate 11, which then itself serves as the building platform.

In FIG. 1, the object 2 to be manufactured is shown in an intermediate state. It consists of a plurality of solidified layers and is surrounded by building material 13 which remains unsolidified. The apparatus 1 furthermore contains a storage container 14 for building material 15 in powder form, which can be solidified by electromagnetic radiation, for example a laser, and/or particle radiation, for example an electron beam. The apparatus 1 also comprises a recoater 16, which is movable in a horizontal direction H, for applying layers of building material 15 within the building area 8. Optionally, a radiation heater 17 for heating the applied building material 15, e.g. an infrared heater, may be arranged in the process chamber.

The device in FIG. 1 furthermore contains an irradiation device 20 having a laser 21, which generates a laser beam 22 that is deflected by means of a deflecting device 23 and focused onto the working plane 7 by means of a focusing device 24 via an entrance window 25, which is arranged at the top side of the process chamber 3 in the chamber wall 4.

The device in FIG. 1 furthermore contains a control unit 29, by means of which the individual component parts of the apparatus 1 are controlled in a coordinated manner for carrying out a method for the manufacture of a three-dimensional object. The control unit 29 may contain a CPU, the operation of which is controlled by a computer program (software). During operation of the apparatus 1, the following steps are repeatedly carried out: For each layer, the support 10 is lowered by a height which preferably corresponds to the desired thickness of the layer of the building material 15. The recoater 16 is moved to the storage container 14, from which it receives an amount of building material 15 that is sufficient for the application of at least one layer. The recoater 16 is then moved over the building area 8 and applies a thin layer of the building material 15 in powder form on the base plate 11 or on the building platform 12 or on a previously applied layer. The layer is applied at least across the cross-section of the object 2, preferably across the entire building area 8. Optionally, the building material 15 is heated to an operation temperature by means of at least one radiation heater 17. The cross-section of the object 2 to be manufactured is then scanned by the laser beam 22 in order to selectively solidify this area of the applied layer. These steps are carried out until the object 2 is completed. The object 2 can then be removed from the container 5.

According to the invention, a powder mixture is used as building material 15. The powder mixture comprises a first powder and a second powder. According to the embodiments described below, the first powder comprises an aluminium alloy or a mixture of elemental precursors thereof in powder form. The second powder comprises a metal powder of Zr and/or Hf.

According to the embodiments described below, the powder mixture is processed by the direct metal laser sintering (DMLS) method. In the selective laser sintering or selective laser melting method small portions of a whole volume of powder required for manufacturing an object are heated up simultaneously to a temperature which allows a sintering and/or melting of these portions. This way of manufacturing an object can typically be characterized as a continuous and/or—on a micro-level—frequently gradual process, whereby the object is acquired through a multitude of heating cycles of small powder volumes. Solidification of these small powder portions is carried through selectively, i.e. at selected positions of a powder reservoir, which positions correspond to portions of an object to be manufactured. As in selective laser sintering or selective laser melting the process of solidification is usually carried through layer by layer the solidified powder in each layer is identical with a cross-section of the object that is to be built. Due to the small volume or mass of powder which is solidified in a given time span, e.g. 1 mm3 per second or less, and due to conditions in a process chamber of such additive manufacturing machines, which can favour a rapid cool-down below a critical temperature, the material normally solidifies quickly after heating.

In conventional sintering and casting methods one and the same portion of building material is heated up to a required temperature at the same time. A whole portion of material required to generate an object is cast into a mould in a liquid form. This volume of building material is therefore held above a temperature level required for melting or sintering for a much longer time compared to the selective laser sintering or selective laser melting method. Large volumes of hot material lead to a low cooling rate and a slow solidification process of the building material after heating. In other words, selective laser sintering or selective laser melting methods can be differentiated from conventional sintering and casting methods by processing of smaller volumes of building material, faster heat cycles and less need for heating up build material with high tolerances for avoiding a premature solidification of the material. These can be counted among the reasons why the amount of energy introduced into the building material for reaching the required temperatures can be controlled more accurately in selective laser sintering or selective laser melting methods. These conditions allow for setting an upper limit of energy input into the powder portions to be processed, which determines a temperature generated in the powder portions, more precisely, that is lower and closer to the melting point of the respective material than in conventional sintering or casting methods.

This advantage makes it possible to minimize common problems of conventional sintering and casting methods. One such phenomenon is dissolution of reinforcement material in a steel melt during manufacturing, especially if a resulting material is thermodynamically unstable. The selective laser sintering or selective laser melting method allows for reducing dissolution by lowering the heating temperatures, for example generated by a laser and/or electron beam, in defined areas of the powder bed and for raising a cooling rate after heating. Thus, the reinforcing quality of the reinforcement material, i.e. its ability to change (mechanical) properties of an object in a favourable manner, can become much more apparent. The phrase “mechanical properties of an object” is understood in this context as properties which derive from material properties of the object and not from a specific shape and/or geometry of the object. Mechanical properties of the object can be tensile strength or yield strength, for example.

An object generated from a powder mixture according to the invention may show a change of various mechanical properties, but most notably shows a suppression of crack formation. The inventive method of manufacturing a three-dimensional object thus may provide considerable advantages by improving the mechanical properties compared to an object manufactured without a Zr and/or Hf metal powder. Further, a comparatively short exposure of the building material or the processed material to high temperatures leads to a minimization of the dissolution of the optional reinforcement material in the aluminium alloy material. Furthermore, chemical reactions of the reinforcement material with the aluminium alloy material are minimized. This is important as the reaction products are generally brittle. If the layer of the reaction product is thick, a considerable weakening of the material can occur.

In the following, the present invention is further illustrated by mean of examples, which however should not be construed as limiting the invention thereto in any manner.

### EXAMPLES

### Example 1

For samples 1 and 2 below, a composite material of the Al7017 alloy type was manufactured by dry mixing powders of an Al7017 pre-alloy (d50=38 μm), a Zr-powder (d50=30 μm) and either a B₄C powder (d50=13 μm) or a TiC nanopowder (d50<40 nm). The Al7017 had the following composition: 0.42 wt.-% Si, 0.5 wt.-% Fe, 0.11 wt.-% Cu, 0.27 wt.-% Mn, 2.8 wt.-% Mg, 4.7 wt.-% Zn, and 0.23 wt.-% Zr.

For samples 3 and 4 a dry powder mixture of an Al7017 pre-alloy (d50=48 μm) with the composition 0.44 wt.-% Si, 0.43 wt.-% Fe, <0.01 wt.-% Cu, 0.24 wt.-% Mn, 2.5 wt.-% Mg, 4.6 wt.-% Zn, and 0.2 wt.-% Zr was used in addition to Zr and TiC-additives. In these samples, the respective additives were a Zr-powder (d50=30 μm) and a TiC powder (d50=1.4 μm). All respective raw materials were obtained from commercial powder producers. The composition of the powder mixtures are provided in the below Table I.

TABLE I
Compositions of the powder mixtures

| | Sample 1 | Sample 2 | Sample 3 | Sample 4 |
|---|---|---|---|---|
| Al-alloy powder | balance | balance | balance | balance |
| Zr | 2.9 | 3.0 | 3.0 | 3.0 |
| TiC (nm) | 0.7 | | | |
| TiC (μm) | | | 0.7 | |
| B₄C | | 0.6 | | |

The powder mixture was fabricated by dry mixing the ingredients mechanically using a commercially available Merris SpinMix 550 blender with the mixing time of 450 min (sample 1) and 90 min (samples 2 to 4) and mixing speed of approximately 20 rpm.

The compositions as described in table 1 were processed to 3D-objects by DMLS in an EOS M290 or M280 machine. Appropriate DMLS processing parameters were determined by screening trials, which included building sample parts with varying values of laser output power P, laser hatch distance d and laser speed v. The heat input to the material while processing with a layer thickness S can be described as follows:

Q=P/(d*v*S)

The heat input factor Q is a measure of the amount of energy introduced per volume of the powder material. Heat input factor between 20 and 140 J/mm³ and laser spot size between 35 and 120 μm were found to lead to favourable properties of the manufactured objects.

The density of the test objects was quantified by studying the sample crosscuts with an optical microscope, by which the possible defects, pores and cracks can be seen as optical contrast differences. In the crosscuts, the areal defects were qualitatively estimated form the micrographs. In the micrographs evenly distributed darker phases could be seen. In addition, in samples 2 and 3 second phases of different darkness and about comparable size could be seen, while in sample 1 very small details, which are evenly distributed in the structure could be detected.

The produced samples were free of pores and cracks.

The thus prepared samples were subjected to a subsequent heat treatment at 440° C. for 60 Min followed by quenching in water and a final aging at 120° C. for 24 h.

The tensile testing of the test objects was done according to EN ISO 6892-1: 2016, and the samples were machined according to ISO 6892-1: 2016(E) Annex D. The samples were build in the horizontal direction and were tested both in the as-manufactured and heat treated (HT) state.

The results of the mechanical testing including the ultimate tensile strength (Rm), yield strength (Rp0.2) and elongation (A) are provided in Table II below.

TABLE II
Average tensile testing results of the developed material composition
in the as-manufactured state and after heat treatment.

| | | |
|---|---|---|
| Rm [Mpa] | Rp0.2 [Mpa] | A [%] |

Sample 1

| | | | |
|---|---|---|---|
| As-manufactured | 365 | 360 | 9.5 |
| HT | 485 | 475 | 7 |

Sample 2

| | | | |
|---|---|---|---|
| As-manufactured | 330 | 260 | 12 |
| HT | 490 | 460 | 6 |

Sample 3

| | | | |
|---|---|---|---|
| As-manufactured | 345 | 335 | 4.5 |
| HT | 480 | 475 | 8 |

Sample 4

| | | | |
|---|---|---|---|
| As-manufactured | 340 | 335 | 5 |
| HT | 475 | 460 | 8.5 |

As is apparent from the above, the further heat treatment provides a significant increase in both the tensile and yield strength. In addition, the concomitant use of TiC or B₄C-particles provides for a further improvement of the mechanical properties compared to a sample with only the Zr-powder.

### Example 2

A composite material of the Al7075 alloy type was manufactured by dry mixing powders of an Al7075 pre-alloy (d50=48 μm), a Zr-powder (d50=30 μm) and a B₄C powder (d50=13 μm). The Al7075 had the following composition: 0.08 wt.-% Si, 0.17 wt.-% Fe, 0.22 wt.-% Cr, 1.7 wt.-% Cu, 0.008 wt.-% Mn, 2.0 wt.-% Mg, 5.3 wt.-% Zn, and 0,004 wt.-% Zr. The respective raw materials were obtained from commercial powder producers. The composition of the powder mixtures are provided in the below Table III.

TABLE III
Composition of the powder mixture

| | Sample 5 |
|---|---|
| Al-alloy powder | balance |
| Zr | 4.0 |
| B₄C | 0.8 |

The powder mixture was fabricated by dry mixing the ingredients mechanically using a commercially available Merris SpinMix 550 blender with the mixing time of 90 min and mixing speed of approximately 20 rpm.

The composition as described in table III was processed to 3D-objects by DMLS in an EOS M290 machine. Appropriate DMLS processing parameters were determined by screening trials, which included building sample parts with varying values of laser output power P, laser hatch distance d and laser speed v as describes in example 1, were also a heat input factor of between 20 and 140 J/mm³ and a laser spot size between 35 and 120 μm were found to lead to good properties of the manufactured objects.

The produced samples were free of pores and cracks.

The thus prepared samples were subjected to a subsequent heat treatment of 440° C. for 60 Min followed by quenching in water and a final aging at 120° C. for 24 h.

The tensile testing of the test objects was done as described in Example 1. The results of the mechanical testing including the ultimate tensile strength (Rm), yield strength (Rp0.2) and elongation (A) are provided in Table IV below.

TABLE IV
Average tensile testing results of the developed material composition
in the as-manufactured state and after heat treatment.

| | Rm [Mpa] | Rp0.2 [Mpa] | A [%] |
|---|---|---|---|
| As-manufactured | 336 | 292 | 9 |
| HT | 566 | 559 | 3 |

### LIST OF REFERENCE SIGNS

1 laser sintering or laser melting apparatus
2 three-dimensional object
3 process chamber
4 chamber wall
5 container
6 container wall
7 working plane
8 building area
10 support
11 base plate
12 building platform
13 building material
14 storage container
15 building material
16 recoater
17 radiation heater
20 irradiation device
21 laser
22 laser beam
23 deflecting device
24 focusing device
25 entrance window
29 control unit

1. Powder mixture for use in the manufacture of a three dimensional object by means of an additive manufacturing method, wherein the powder mixture comprises a first material and a second material, wherein the first material comprises an aluminium alloy or a mixture of elemental precursors thereof and is in powder form, and wherein the second material comprises a metal powder of Zr and/or Hf.

2. Powder mixture according to claim 1, wherein the first material comprises aluminium and 4.0 to 6.1 wt.-% Zn, 1.5 to 3.0 wt.-% Mg, up to 0.6 wt.-% Fe, up to 0.50 wt.-% Si, and one or more of up to 0.35 wt.-% of Cr, up to 0.5 wt.-% of Mn, up to 2.0 wt.-% of Cu, up to 0.25 wt.-% of Ti and 0.1 to 0.25 wt.-% of Zr.

3. Powder mixture according to claim 2, wherein the first material comprises less than or equal to 0.25 wt.-% of Cu, less than or equal to 0.35 wt.-% of Cr and 0.05 to 0.5 wt.-% of Mn, and wherein the combined amount of Mn and Cr is >0.15 wt.-%.

4. Powder mixture according to claim 1, wherein the median grain size d50, as determined by laser scattering or laser diffraction, of the first material is 1 μm or more, and/or 150 μm or less.

5. Powder mixture according to claim 1, wherein the second material accounts for 1 to 5 wt. % and/or 4.5 wt.-% or less of the powder mixture.

6. Powder mixture according to claim 1, wherein the median grain size d50, as determined by laser scattering or laser diffraction, of the second material is 1 μm or more and/or 100 μm or less and wherein the median grain size d50 of the second material is less than that of the first material.

7. Powder mixture according to claim 1, further comprising a reinforcement material selected from carbides, borides and nitrides.

8. Powder mixture according to claim 7, wherein the reinforcement material is selected from the group consisting of TiC, ZrC, Nb₂C, Ta₂C, Al₄C, HfC, TaC, NbC, VC, SiC, B₄C, NbB₂, TaB₂, VN, NbN, AlN, TaN, Nb₂N, Ta₂N and BN or mixtures thereof.

9. Powder mixture according to claim 1, wherein the amount of the reinforcement material in the powder mixture is 0.1 wt.-% or more and/or wherein the content of the reinforcement material in the powder mixture is 3 wt.-% or less.

10. Powder mixture according to claim 1, wherein the median grain size d50, as determined by laser scattering or laser diffraction, of the reinforcement material is equal to or less than 50 μm, and wherein the median grain size d50 of the reinforcement material is less than that of the first and second material.

11. Process for the preparation of a powder mixture according to claim 1, wherein the powder mixture is produced by mixing the first material, the second material and the reinforcement material in a predetermined mixing ratio.

12. Process for the manufacture of a three-dimensional object, comprising providing a powder mixture as defined in claim 1, and preparing the object by applying the mixture layer on layer and selectively consolidating the mixture at positions in each layer, which correspond to the cross section of the object in this layer, wherein the positions are scanned with an interaction zone.

13. Process according to claim 12, wherein the melting involves the introduction of an amount of energy per volume of the powder mixture of 20 J/mm³ or more and/or of 140 J/mm³ or less.

14. Process according to claim 12 further comprising subjecting the thus prepared three-dimensional object to a heat treatment at a temperature from 400° C. to 500° C., and/or for a time of 20 to 200 Min.

15. Three-dimensional object prepared from a powder mixture according to claim 1 and wherein the three-dimensional object comprises or consists of such mixture in solidified form.

16. Three-dimensional object according to claim 15, wherein the material of the three-dimensional object has an ultimate tensile strength of more than 400 MPa, and/or a yield strength of more than 300 MPa, and/or an elongation of equal to or less than 15%.

17. Use of a powder mixture according to claim 1 for improving one or more of the ultimate tensile strength and/or the yield strength of an aluminium alloy based three-dimensional object, wherein the three-dimensional object is prepared in a process involving the step- and layerwise build-up of the three dimensional object by additive manufacturing.

18. Device for implementing a process according to claim 12, wherein the device comprises an electromagnetic radiation application device, a process chamber having an open container with a container wall, a support, which is inside the process chamber, wherein process chamber and support are moveable against each other in vertical direction, a storage container and a recoater, which is moveable in horizontal direction, and wherein the storage container is at least partially filled with a powder mixture.
